(19) United States
(12) Patent Application Publication
(10) Pub. No.: US 2024/0385994 A1
(43) Pub. Date: Nov. 21, 2024

(54) DYNAMIC LOG REPLICATION

(71) Applicant: VMware, Inc., Palo Alto, CA (US)

(72) Inventors: Pankti Vinay Majmudar, Santa Clara, CA (US); Sundararaman Sridharan, Fremont, CA (US); Anny Martinez, Mountain View, CA (US); Medhavi Dhawan, Saratoga, CA (US); Shama Hegde, Sunnyvale, CA (US)

(21) Appl. No.: 18/199,892

(22) Filed: May 19, 2023

(51) Int. Cl. G06F 16/178

(52) U.S. Cl. CPC G06F 16/178

(57) ABSTRACT

The disclosure provides an approach for managing log replication between data centers. Certain aspects provide log replicators that monitor application data stored in a log based data base. The log replicators are configured on each data center and replicate data between one another based on configuration parameters, including a replication model. The log replicators may be able to dynamically discover new applications and replicate data stored in the log for new applications dynamically.

### BACKGROUND

A data center comprises a plurality of physical machines in communication over a physical network infrastructure. In certain cases, a physical host machine includes one or more virtualized endpoints, such as virtual machines (VMs), containers, or other types of virtual computing instances (VCIs). Applications of an entity (e.g., organization, company, etc.) may execute directly on physical machines or in the VMs or other types of VCIs and communicate with each other over one or more networks in the data center.

Often times, the entity may leverage multiple data centers for running applications. Use of multiple data centers can provide several advantages. For example, where instances of an application run on different data centers, should one data center become unavailable or have an error, the application may still be available on another data center, thereby providing fault tolerance. The data centers may be in different geographical locations (e.g., Europe, United States, etc.).

As part of running applications on multiple data centers, it may be important to provide mechanisms for sharing data across the multiple data centers. For example, multiple instances of an application may run on different data centers, and the instances may need to share data across the data centers.

### BRIEF DESCRIPTION OF THE DRAWINGS

FIG. 1 is a diagram illustrating an example computing environment in which embodiments of the present application may be practiced.

FIG. 2 is a flowchart of an example method to instantiate a replicator for a new application, according to an example embodiment of the present application.

FIG. 3 is a flowchart of an example method to instantiate a data writer for a new application, according to an example embodiment of the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides improved systems and methods for managing log replication across multiple data centers, such as data centers in different geographical regions.

In certain aspects, an application may be running in multiple different data centers. In particular, a local instance of the application may run in each of the data centers. As an illustrative example, the application may be a policy manager that is configured to control network policy for the data centers, such as for managing one or more logical overlay networks. For example, a policy manager may be configured to manage a network policy across the multiple different data centers to provide a continuity of access to services and data across the data centers. The network may be managed as a “federated network.” A federated network has a central management framework that enforces consistent configuration and policies across each data center. While management, control, and data planes are distributed over multiple data centers, the planes are managed as a single entity. Accordingly, in certain aspects, a global policy manager may run in one data center. The global policy manager ensures that configuration and policies are consistently maintained at local policy managers at the multiple different data centers. For example, an instance of a local policy manager may run in each data center. The local policy manager at each data center may configure components of the data center to enforce the configuration and polices pushed from the global policy manager, thereby ensuring that consistent network policy is enforced across the data centers. For example, this facilitates an administrator setting policies for the entire federated network at the global policy manager, which is then pushed to the local policy managers to set policy across all the data centers, rather than configuring policies for each data center separately. A logical network configuration and the global and local policy managers, referred to as global and local network managers, are described in greater detail in U.S. patent application Ser. No. 16/906,944, now issued as U.S. Pat. No. 11,088,916, entitled “Parsing Logical Network Definition for Different Sites”, which is incorporated herein by reference. Though certain aspects are discussed with respect to a federated system, the techniques herein are applicable to non-federated systems as well.

Certain aspects herein allow sharing of data (e.g., network policy information) between applications (e.g., policy managers) in different data centers through the use of log replication. For example, the application may be configured to store data in a log (e.g., as events stored as streams of data in tables). For example, each data center may maintain a local instance of a log (e.g., a shared log), which may be part of a database system, such as CorfuDB. Where the application is a policy manager, network policy data may be stored in the log. Accordingly, each data center may include a local instance of an application, which may store data in a local instance of a log. Further, a global instance of the application may run in one of the data centers or a separate data center (e.g., in a cloud environment), and may maintain a global instance of the log. In certain aspects, changes to local instances of the log are replicated to the global instance of the log, and updates to the global instance of the log are replicated to the local instances of the log to ensure data consistency across the local instances of the log in the different data centers. In particular, certain aspects herein provide log replicators running in the data centers to replicate the logs across the data centers.

For example, the global policy manager receives globally desired configurations (e.g., access policies, firewall policies, network configurations, etc.) for a logical network via one or more services. As the configurations are received by the global policy manager, they are stored in a log based database, such as one or more streaming tables. In certain aspects, the global policy manager then identifies a relevant portion of the configurations for each data center, and provides the identified portion to the data center's corresponding local policy manager from the database. In addition, the local policy managers may collect information about the state of the logical network at the corresponding data center to be provided to the global policy manager. The local policy managers store the state information in tables of a local database. The state information is then provided to the global policy manager from the database. The global policy manager may then provide this aggregated information (e.g., to an administrator of the logical network) for troubleshooting and management purposes.

In certain aspects, the log replicators support one or more types of replication models. One model includes one-to-one, where replication between one log replicator and another log replicator, such as between one data center and another data center. Another model includes one-to-many, where replication occurs from one log replicator to many other log replications, such as from a global log to many local logs (e.g., from one data center to many other data centers). Another model includes many-to-one, where replication occurs from many log replicators to one log replicator, such as from many local logs to a global log (e.g., from many data centers to one data center).

In certain aspects, log replicators replicate events stored on streaming tables to one or more log replicators at other data centers. When a log replicator is replicating events, it is sometimes referred to as a “source log replicator”. When a log replicator is receiving events, it is sometimes referred to as a “sink log replicator.” A source log replicator replicates events stored in a log to one or more sink log replicators to store in a corresponding log, such as according to configuration data that specifies (i) the subscriber of the data (e.g., the application that is the owner of the data) and/or (ii) replication model. The configuration data may be changed or updated during operation of the log replicator to dynamically configure how the log data is replicated.

Replication of data from a source log replicator to a sink log replicator may include the source log replicator sending a copy of the data to the sink log replicator. In another example, replication of data from a source log replicator to a sink log replicator includes the source log replicator sending an indication of the data to the sink log replicator. For example, where a function is applied to a first set of data managed by a source log replicator, the source log replicator may send an indication of the function to the sink log replicator to allow the sink log replicator to perform the function on the first set of data stored at the sink log replicator, thereby replicating the data without sending the data itself.

In certain aspects, the configuration data specifies how the log data is replicated by specifying what portions of the log data is replicated and/or how to modify log data that is replicated. In certain aspects, the log replicators are configured to replicate an exact replica of the data stored. In certain aspects, the log replicators are configured to replicate a derivative of data as opposed to an exact replica of the data stored. A derivative of data may refer to a subset of the original data stored and/or a transformation of the original data stored. A transformation of the original data stored may be application of any function to the original data stored. In certain aspects, a source log replicator may be configured to replicate different derivatives of data to different sink log replicators.

For example, for a first set of data corresponding to a first application, a source log replicator may be configured to replicate a subset (i.e., less than all) of the first set of data (e.g., one or more columns or rows of a table, one or more entries, one or more events, etc.) to a sink log replicator. In some aspects, a source log replicator may be configured to replicate different subsets (e.g., different columns, rows, entries, events, etc.) to different sink log replicators.

As another example, for a first set of data corresponding to a first application, a source log replicator may be configured to replicate a transformation of the first set of data to a sink log replicator. For example, the source log replicator may be configured to apply a function to the first set of data (e.g., shift data, add, subtract, concatenate, etc.) and send the transformed first set of data to the sink log replicator. As another example of transformation, where a function is applied to the first set of data managed by the source log replicator, the source log replicator may send an indication of a different function to the sink log replicator to allow the sink log replicator to perform the different function to create derivative data at the sink log replicator.

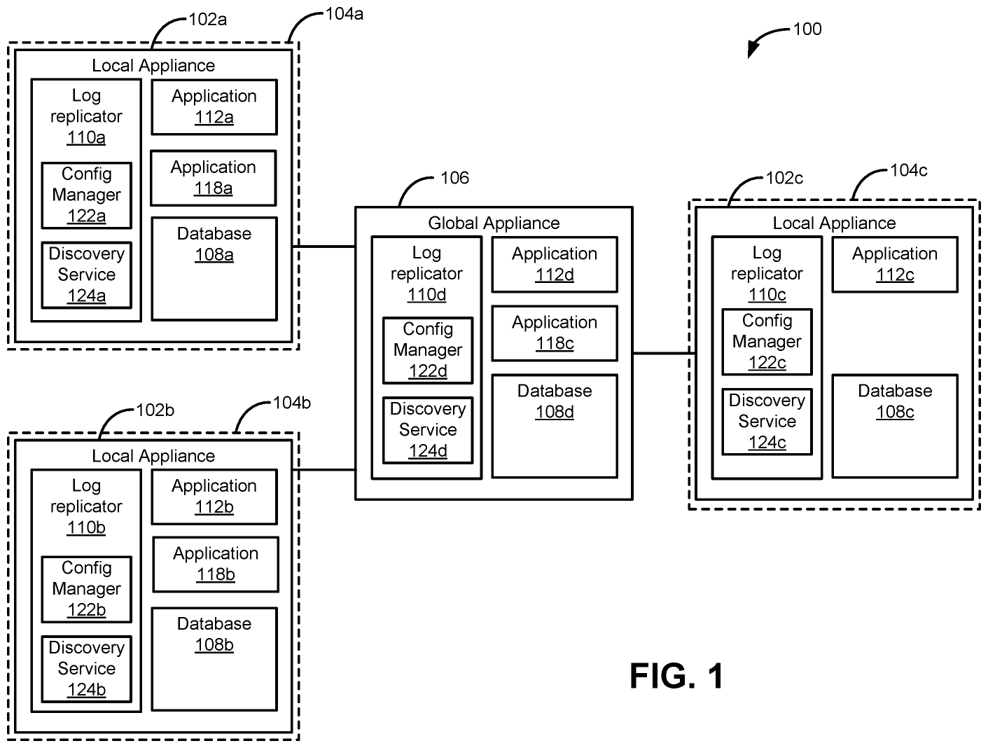

FIG. 1 illustrates an example federated system 100 in which embodiments of the present application may be practiced. The federated system 100 includes local appliances 102a, 102b, and 102c (individually referred to as local appliance 102, and collectively as local appliances 102). Each local appliance 102 is in a different data center. In particular, local appliances 102a, 102b, and 102c are in data centers 104a, 104b, and 104c, respectively (individually referred to as data center 104, and collectively as data centers 104). Each local appliance 104 may be a physical computing device, a VCI (e.g., running on a physical computing device), or a set of physical computing devices or VCIs. For example, a physical computing device may include hardware such as one or more central processing units, memory, storage, and physical network interface controllers (PNICs). A virtual device may be a device that represents a complete system with processors, memory, networking, storage, and/or BIOS, that runs on a physical computing device. For example, the physical computing device may execute a virtualization layer that abstracts processor, memory, storage, and/or networking resources of the physical device into one more virtual devices. Another example of a virtual device is a container that shares an operating system of the physical computing device.

Additionally, the federated system 100 includes a global appliance 106. The global appliance 106 may be a physical computing device, a VCI, or a set of physical computing devices or VCIs. The global appliance 106 may be in one of the data centers 104a-104c, or may be in a separate data center. In an example, data centers 104a-104c are separate private clouds, and the global appliance 106 is in a public cloud. In certain aspects, each data center 104 includes at least one gateway (not shown) which may provide components (e.g., local appliance 102) in data center 104 with connectivity to one or more networks used to communicate with one or more remote data centers and/or other devices/servers. In certain aspects, the local appliances 102 are communicatively coupled to the global appliance 106 over, for example, a wide area network, such as the Internet.

Though only one local appliance 102 is shown in each data center 104, there may be more than one local appliance 102 in each data center 104, such as for redundancy, where each local appliance 102 manages a different portion of data center 104, and/or the like. Similarly, there may be more than one global appliance 106. Further, though three data centers 104 are shown, there may be additional or fewer data centers 104, and correspondingly additional or fewer local appliances 102.

Each of the local appliances 102 and global appliance 106 run a log replicator 110 (shown as log replicators 110a-110d individually referred to as log replicator 110, and collectively as log replicators 110) and a database 108 (shown as databases 108a-108d individually referred to as database 108, and collectively as databases 108) (e.g., a CorfuDB). In certain aspects, each database 108 is a log based database that stores data in one or more logs. Further, as discussed further herein, a log replicator 110 may be a process or set of processes configured to monitor for changes to data stored in the database 108 running on the same appliance 102/106 as the log replicator 110 and replicate the data to one or more other log replicators 110. In another example, a log replicator 110 may be configured to receive replication information from another log replicator 110, and update a log of a corresponding database 108.

The local appliances 102 and global appliance 106 are configured to run applications (e.g., network policy managers, intrusion detection systems, firewalls, etc.) that read, write, and/or modify data stored in databases 108. As shown, local appliance 102a runs applications 112a and 118a, local appliance 102b runs applications 112b and 118b, local appliance 102c runs application 112c, and global appliance 106 runs applications 112d and 118c. In certain aspects, applications 112a, 112b, 112c, and 112d are instances of the same application, referred to as application 112. In certain aspects, applications 118a, 118b, and 118c are instances of the same application, referred to as application 118.

In an example, application 112 is a network policy manager, wherein applications 112a-112c are local policy managers, and application 112d is a global policy manager. In certain such aspects, applications 112a-112c use configuration data received from application 112d that is stored in the database 108d to generate local configuration data for services operating at the corresponding data centers 104a-c. In some examples, applications 112a-112c may receive one or more events as a series of application programming interface (API) transactions, with each event affecting policy or configuration at the corresponding data center 104a-c. Applications 112a-112c may further store data corresponding to such one or more events in databases 108a-108c, respectively.

Further, in certain such aspects, configuration data, such as desired configuration of a network, is received by the application 112d from one or more user clients. An administrator may, for example, configure the network and/or define network policies, firewall policies, security groups, etc. through the application 112d. For example, the application 112d may receive firewall policies to be applied to firewalls operating at the different data centers 104a-c. In some examples, the configuration data is received as one or more events, such as a series of API transactions, with each event affecting policy or configuration at one or more of the data centers 104a-c. Application 112d may further store data corresponding to such one or more events in database 108d. Additionally, the application 112d may maintain a registry table that specifies local appliances 102a-102c and their network locations. The registry table reflects the topology of the applications running on the local appliances 102 and the global appliance 106. As applications are instantiated and terminated across the data centers 104, the application 112d updates the registry table. The registry table may be stored in database 108d and further replicated to databases 108a-c by log replicators 110a-d, according to the techniques discussed herein.

In the illustrated example, log replicators 110a-d include configuration manager 122a-122d (individually referred to as configuration manager 122, and collectively as configuration managers 122), respectively, and discovery services 124a-124d (individually referred to as configuration manager 122, and collectively as configuration managers 122), respectively.

In certain aspects, configuration manager 122 maintains configuration parameters for the applications running on the same appliance as the configuration manager 122. In certain aspects, for each application, a configuration parameter specifies (i) an identifier of the application, (ii) an identifier of data to replicate (e.g., one or more tables, one or more transformation functions, one or more subsets, etc.), such as a derivative of data to replicate, and (iii) a replication model.

In certain aspects, discovery service 124 dynamically discovers applications, running on the same appliance as the discovery service 124, for which to replicate data. In certain aspects, discovery service 124 monitors the registry table to detect changes in applications. For example, when application 118c starts running on global appliance 106, discovery service 124 is configured to discover that application 118c is running.

In certain aspects, when discovery service 124 detects a new application running on an appliance, log replicator 110 running on the appliance may create configuration parameters, state machines, and data readers (also referred to as “replicators”) associated with the application to begin reading data stored in database 108 on the appliance, and then replicate that data to other log replicators 110 based on the configuration parameters. For example, when application 118c starts running on global appliance 106, discovery service 124 creates configuration parameters, state machines, and data readers that run on global appliance 106, read data associated with application 118c from database 108d, and replicate the data to other log replicators (e.g., log replicators 110a and 110b based on local appliances 102a and 102b running instances of application 118, and not log replicator 110c based on local appliance 102c not running an instance of application 118).

In certain aspects, when log replicator 110 running on an appliance determines a new application is running on another appliance, the data of which is to be replicated at the appliance where log replicator 110 is running, log replicator 110 creates a data writer to write replicated data to database 108. For example, based on a registry table replicated by log replicator 110d from database 108d to log replicators 110a-110c, which store the registry table data in databases 108a-c, respectively, log replicators 110a and 110b determine that application 118 is running on each of local appliance 102a, 102b, and global appliance 106. Further, the configuration associated with application 118 may indicate a one-to-many replication from the global appliance 106 to local appliances 102a and 102b. Accordingly, log replicators 110a and 110b create data writers on local appliances 102a and 102b, respectively, to write replicated data to databases 108a and 108b, respectively, as received from log replicator 110d.

As the discovery service 124 is able to discover new applications, replication for applications running on appliances across data centers can occur dynamically, such that even as new application are added, replication can occur for such new applications, and not just applications that were running when the log replicator 110 was first started.

Further, the configuration manager 112 can dynamically change configuration parameters, such that how data is replicated can be dynamically changed.

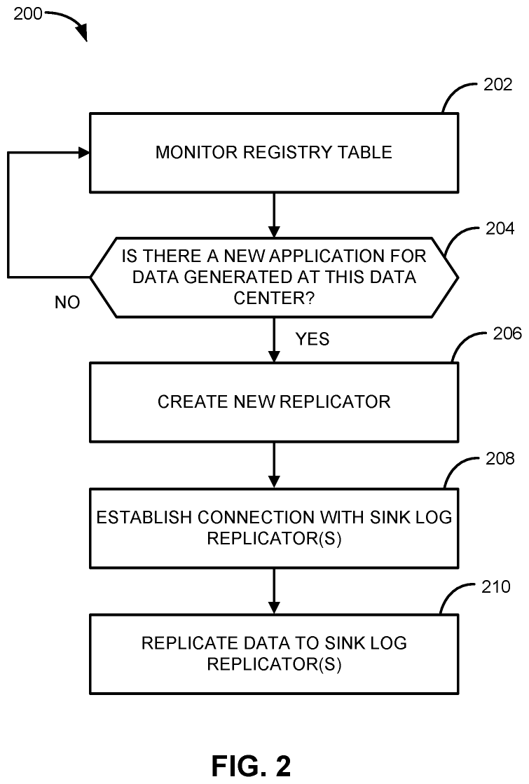

FIG. 2 is a flowchart of an example method for replicating data from a database. Operations 200 may be, for example, independently performed by one or more of the log replicators 110a-110d. For purposes of illustrations, operations 200 are discussed with respect to log replicator 110d.

The operations 200 being at step 202 with monitoring, by the discovery service 124d, a registry table stored in database 108d for an indication of a new application instantiated at any of the data centers 104a-c.

Operations 200 continue at step 204 with determining, by the discovery service 124d, if there is a new application instantiated at any of the data centers 104a-c that uses data stored in database 108d. In some examples, the discovery service 124d retrieves the configuration parameters for the new application, such as provided by an administrator. For example, the configuration parameters may specify one or more of (i) an identifier of the application, (ii) an identifier of data stored in database 108d to replicate (e.g., one or more tables, one or more transformation functions, one or more subsets, etc.), and (iii) a replication model.

When there is a new application instantiated that uses data stored in database 108d, operations 200 continue at step 206 with creating, by the source log replicator 110d, a new replicator for the new application. The replicator is configured to monitor the database 108d as specified by the configuration parameters and replicate changes to the data based on the replication mode. For example, the replicator may monitor certain subsets (e.g., certain tables, certain rows and/or columns of tables, etc.) of data stored in database 108d as indicated in the configuration parameters.

Operations 200 continue at step 208 with establishing, by the source log replicator 110d, a connection with a sink log replicator of the destination appliance where the new application is running. In certain aspects, the source log replicator 110d may establish a connection with each of multiple sink log replicators, where there are multiple instances of the new application running on multiple destination appliances. For example, source log replicator 110d may establish connections with each of sink log replicators 110a-110c on local appliances 102a-102c, respectively.

Operations 200 continue at step 210 with replicating, by the log replicator 110d, the changes to data monitored at the database 108d to the sink log replicator(s) with which the connection is established at step 208 based on the configuration parameters. In certain aspects, based on the configuration parameters, replicating includes sending actual changed data as stored in database 108d to the sink log replicators.

In certain aspects, based on the configuration parameters, replicating includes replicating a derivative of the data stored in database 108d. For example, in certain aspects, based on the configuration parameters, replicating includes reading data as stored in database 108d, transforming the data, and sending the transformed data to the sink log replicators. In certain aspects, based on the configuration parameters, replicating includes determining a transformation (e.g., function) applied to data stored in database 108d, and sending an indication of the transformation to the sink log replicators.

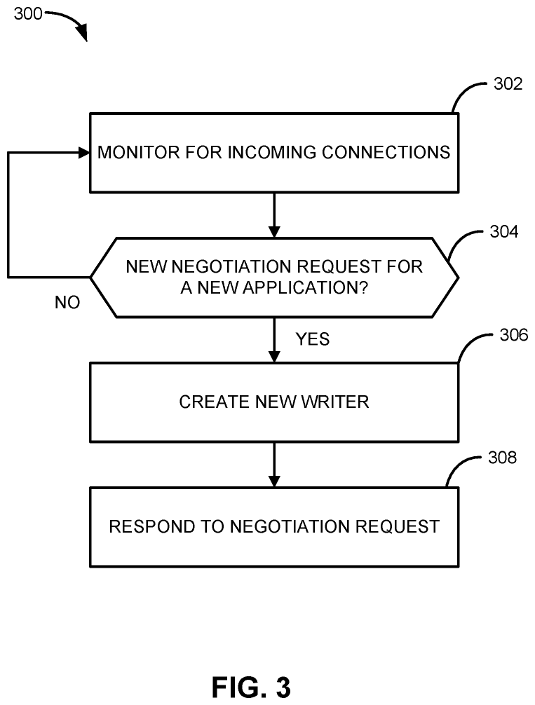

FIG. 3 is a flowchart of an example method for replicating data to a database. Operations 300 may be, for example, independently performed by one or more of the log replicators 110a-110d. For purposes of illustrations, operations 300 are discussed with respect to log replicator 110a.

Operations 300 begin with monitoring, by the sink log replicator 110a, for incoming connections from a source log replicator. For example, source log replicator 110d may establish a connection with sink log replicator 110a at step 208 of operations 200.

The operations 300 continue with step 304 with determining whether there is a new negotiation request for a new application. For example, source log replicator 110d may send data updating a registry table at sink log replicator 110a, the registry table indicates a new application is running on local appliance 102a for which data is to be replicated in database 108a, which may correspond to a new negotiation request.

When there is a new negotiation request, the operations 300 continue at step 306 with creating a data writer. For example, the sink log replicator 110a creates a data writer that writes replicated data based on information received from source log replicator 110d. The data writer writes the replicated data to database 108a. In some examples, the data writer transforms or otherwise modifies the data, meaning the data writer generate derivative data. In certain aspects, the information received from the source log replicator 110d includes actual data to be written to database 108a. In certain aspects, the information received from the source log replicator 110d includes an indication of derivative data, such as a transformation to apply to data stored in database 108a. For example, the information may indicate to add a constant to all values stored in a particular row of a table in database 108a.

Operations 300 continue at step 308 with responding, by the sink log replicator 110a, to the negotiation request to begin to receive the replicated data from the source log replicator 110d.

In certain aspects, multiple applications store data to the same log. Further, each application may be associated with a different set of configuration parameters for replication. In certain aspects, different configuration parameters may indicate different derivatives of data to replicate, such as different subsets of data within the same log.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for replicating log data across data centers, the method comprising:
monitoring a log stored in a first data center;
determining, based on configurations parameters associated with the log, a replication model associated with replicating the data stored in the log, the replication model indicating one or more data centers to which to replicate the data stored in the log;
determining, based on the configuration parameters, a derivative of the data stored in the log; and
sending, to the one or more data centers, an indication of the derivative of the data stored in the log.

2. The method of claim 1, wherein the derivative of the data stored in the log comprises a function applied to the data stored in the log.

3. The method of claim 1, wherein the derivative of the data stored in the log comprises a subset of the data stored in the log.

4. The method of claim 1, further comprising:
determining, based on second configurations parameters associated with the log, a second replication model associated with replicating the data stored in the log, the second replication model indicating one or more second data centers to which to replicate the data stored in the log, the one or more second data centers different than the one or more data centers;
determining, based on the second configuration parameters, a second derivative of the data stored in the log, wherein the second derivative of the data is different than the first derivative of the data; and
sending, to the one or more second data centers, an indication of the second derivative of the data stored in the log.

5. The method of claim 4, wherein the replication model is associated with a first application, and the second replication model is associated with a second application.

6. The method of claim 1, further comprising:
monitoring for start of an application that stores data in the log; and
based on discovering the start of the application, creating the configuration parameters associated with the log.

7. The method of claim 1, wherein the one or more data centers comprise a plurality of data centers.

8. One or more non-transitory computer-readable media comprising instructions, which when executed by one or more processors, cause the one or more processors to perform operations for replicating log data across data centers, the operations comprising:
monitoring a log stored in a first data center;
determining, based on configurations parameters associated with the log, a replication model associated with replicating the data stored in the log, the replication model indicating one or more data centers to which to replicate the data stored in the log;
determining, based on the configuration parameters, a derivative of the data stored in the log; and
sending, to the one or more data centers, an indication of the derivative of the data stored in the log.

9. The one or more non-transitory computer-readable media of claim 8, wherein the derivative of the data stored in the log comprises a function applied to the data stored in the log.

10. The one or more non-transitory computer-readable media of claim 8, wherein the derivative of the data stored in the log comprises a subset of the data stored in the log.

11. The one or more non-transitory computer-readable media of claim 8, wherein the operations further comprise:
determining, based on second configurations parameters associated with the log, a second replication model associated with replicating the data stored in the log, the second replication model indicating one or more second data centers to which to replicate the data stored in the log, the one or more second data centers different than the one or more data centers;
determining, based on the second configuration parameters, a second derivative of the data stored in the log, wherein the second derivative of the data is different than the first derivative of the data; and
sending, to the one or more second data centers, an indication of the second derivative of the data stored in the log.

12. The one or more non-transitory computer-readable media of claim 11, wherein the replication model is associated with a first application, and the second replication model is associated with a second application.

13. The one or more non-transitory computer-readable media of claim 8, wherein the operations further comprise:
monitoring for start of an application that stores data in the log; and
based on discovering the start of the application, creating the configuration parameters associated with the log.

14. The one or more non-transitory computer-readable media of claim 8, wherein the one or more data centers comprise a plurality of data centers.

15. A computer system comprising:
one or more processors; and
memory storing instructions, which when executed by the one or more processors, cause the one or more processors to perform operations for replicating log data across data centers, the operations comprising:
monitoring a log stored in a first data center;
determining, based on configurations parameters associated with the log, a replication model associated with replicating the data stored in the log, the replication model indicating one or more data centers to which to replicate the data stored in the log;
determining, based on the configuration parameters, a derivative of the data stored in the log; and
sending, to the one or more data centers, an indication of the derivative of the data stored in the log.

16. The computer system of claim 15, wherein the derivative of the data stored in the log comprises a function applied to the data stored in the log.

17. The computer system of claim 15, wherein the derivative of the data stored in the log comprises a subset of the data stored in the log.

18. The computer system of claim 15, wherein the operations further comprise:
determining, based on second configurations parameters associated with the log, a second replication model associated with replicating the data stored in the log, the second replication model indicating one or more second data centers to which to replicate the data stored in the log, the one or more second data centers different than the one or more data centers;
determining, based on the second configuration parameters, a second derivative of the data stored in the log, wherein the second derivative of the data is different than the first derivative of the data; and
sending, to the one or more second data centers, an indication of the second derivative of the data stored in the log.

19. The computer system of claim 15, wherein the operations further comprise:
monitoring for start of an application that stores data in the log; and
based on discovering the start of the application, creating the configuration parameters associated with the log.

20. The computer system of claim 15, wherein the one or more data centers comprise a plurality of data centers.
